(19) United States
(12) Patent Application Publication
(10) Pub. No.: US 2009/0173688 A1
(43) Pub. Date: Jul. 9, 2009

(54) SYSTEMS AND METHODS FOR UTILIZATION OF WASTE HEAT FOR SLUDGE TREATMENT AND ENERGY GENERATION

(76) Inventors: Rodger W. Phillips, Vashon, WA (US); Martin J. Shain, Seattle, WA (US); Christian Frison, Seattle, WA (US)

Correspondence Address: K&L Gates LLP, 1900 MAIN STREET, SUITE 600, IRVINE, CA, 92614-7319, US

(21) Appl. No.: 12/362,419

(22) Filed: Jan. 29, 2009

Related U.S. Application Data
(63) Continuation of application No. 11/627,311, filed on Jan. 25, 2007.
Application No. 11/627,311 is a continuation-in-part of application No. 11/379,404, filed on Apr. 20, 2006.
(60) Provisional application No. 60/675,511, filed on Apr. 27, 2005.
(60) Provisional application No. 60/692,099, filed on Jun. 20, 2005.

(51) Int. Cl. C02F 11/14; C02F 11/12

(52) U.S. Cl. 210/609; 210/613

(57) ABSTRACT

Disclosed methods employ systems and methods to treat sludge utilizing waste heat. The disclosed systems and methods can be used to provide a regional sludge treatment service.

### CROSS REFERENCES TO RELATED APPLICATIONS

The present application claims the benefit, under 35 U.S.C. § 120, of U.S. patent application Ser. No. 11/627,311, filed Jan. 25, 2007, which was a continuation-in-part of U.S. patent application Ser. No. 11/379,404, filed Apr. 20, 2006, which claimed the benefit of U.S. Provisional Patent Application Ser. No. 60/675,511, filed Apr. 27, 2005, and U.S. Provisional Patent Application Ser. No. 60/692,099, filed Jun. 20, 2005, the contents all of which are incorporated herein by reference. The present application also claims priority directly to 11/379,404 under 35 U.S.C. § 120.

### FIELD OF THE INVENTION

Disclosed herein are systems and methods that utilize waste heat for sludge treatment and energy generation.

### BACKGROUND OF THE INVENTION

The de-watering and disposal of organic sludge poses significant problems for most industrial and municipal wastewater facilities. One of the problems encountered by these facilities is that the mechanical dewatering of sludge via common technologies such as filter presses, belt presses, and centrifuges, still produces a final product with greater than about 70%-80% water content. Facilities with the proper climate and adequate open space can spread this sludge into thin layers to promote drying to a lower water percentage level over a several month period. Facilities with limited space and/or humid environments, however, are forced to either dispose of sludge with this high water content in landfills or on certain acceptable agricultural crops or grazing fields, or resort to extremely energy-intensive final drying techniques such as, without limitation, those employing direct and indirect drum dryers. Because the cost of final drying in these cases is typically prohibitive, both with respect to capital equipment requirements and operating costs, these facilities are generally forced to dispose of the sludge via the landfill and/or agricultural applications.

In recent years the disposal of sludge in the above described landfill and/or agricultural applications has proven ecologically sensitive. While short term disposal can have a positive effect on crop production, heavy metals and other contaminants in the material make long term disposal problematic, not to mention aesthetically disagreeable in certain areas. Additionally, state and local authorities are enforcing stricter regulatory standards and mandating better management practices for safe sludge disposal and use, making sludge disposal even more difficult for these facilities. These issues will become more and more critical in light of the fact that many wastewater facilities have reached their capacity to process wastewater effluent from an expanding industry and customer base.

Based on the foregoing, there exists a need for additional options for wastewater facilities to dewater, dry, and dispose of organic sludge. The present invention provides such additional beneficial options.

### SUMMARY OF THE INVENTION

Disclosed herein are methods of utilizing waste heat to treat sludge. The methods provide environmentally friendly methods of treating sludge by the use of heat that would otherwise be lost or wasted.

The embodiments disclosed herein include treating sludge utilizing waste heat where the source of the waste heat is selected from the group consisting of a biofuel, a reciprocating engine, a gas generator set, a gas turbine set, landfill, a by-product of landfill degradation or combinations thereof.

In another embodiment, the treatment of sludge can include dewatering the sludge, drying the sludge, and converting the sludge into a second form after it is dried. It is also possible to convert this dried sludge into a second form. Second forms can include, but are not limited to a fuel, electric power, a material suitable for a landfill application, a material suitable for an agricultural application, a material suitable for an industrial application and combinations thereof.

In another embodiment, the treatment of the sludge and converting of the sludge take place at separate locations.

In another embodiment, the waste heat can be obtained from biofuel utilizing an exothermic reaction of the biofuel. One type of exothermic reaction disclosed herein is combustion.

In another embodiment the waste heat can be obtained from the exhaust, coolant or lubricant of a reciprocating engine.

In another embodiment the waste heat can be obtained from the exhaust, coolant or lubricant of a gas generator set.

In another embodiment the waste heat can be obtained from the exhaust, coolant or lubricant of a gas turbine set.

In another embodiment, the waste heat can be obtained from landfill utilizing an exothermic reaction of the landfill. One type of exothermic reaction disclosed herein is an exothermic reaction facilitated by microbes. In another type of exothermic reaction contemplated by the invention, the exothermic reaction is combustion.

In another embodiment, the landfill can be municipal landfill and/or commercial landfill.

In another embodiment, the waste heat can be obtained from an exothermic reaction involving a by-product of landfill degradation. One type of by-product disclosed herein is a volatile organic compound, such as methane. One type of exothermic reaction disclosed herein is combustion.

In another embodiment, the sludge can be accepted from more than one party. In addition, the waste heat can be provided by more than one party. The embodiments disclosed herein can also include utilization of waste heat obtained from a location separate from the location where treating and/or converting the sludge takes place.

### DESCRIPTION OF THE DRAWINGS

FIG. 1 is a block diagram of a system for utilizing waste heat for drying sludge and/or generating fuel and/or energy in accordance with one embodiment of the present invention.

FIG. 2 is a flow chart illustrating a method for utilizing waste heat for drying sludge and/or generating fuel and/or energy in accordance with another embodiment according to the present invention.

### DEFINITION OF TERMS

To aid in understanding the following detailed description according to the present invention, the terms and phrases used herein shall have the following, non-limiting, definitions.

As used herein, the term “source” includes any place, industrial or otherwise, that produces heat that can be used in an amount sufficient to contribute to the treatment of sludge. Sources include but are not limited to plants, factories, mills Turbines, Heat Recovery Steam Generator (HRSG) configuration and stacks, biofuel sources, coolants, lubricants and/or exhaust sources, reciprocating engines, landfills gas generator sets or the sun. As should be understood by this wide range of examples, sources can include any process or physical entity that generates waste heat as defined below.

As used herein, the term “sludge” includes any organic material that can be converted into an energy source at least in part or can be treated through the use of heat. In one embodiment, sludge includes sewage material from wastewater facilities or treatment plants, however the present invention is not so limited and can be used to treat any sort of organic material that can benefit in its conversion to energy, an energy source or energy product or in its disposal from the various sources of heat used in accordance with the present invention. “Sludge” can include, without limitation, raw sludge and/or partially dewatered sludge.

As used herein, the term “raw sludge” includes sludge that has not been digested at all or has been digested through a process resulting in about 5% or less reduction in volatile solids content.

As used herein, the term “partially dewatered sludge” includes sludge that has been through a dewatering process but still retains a moisture content of greater than about 10%.

As used herein, the term “separate locations” means at least two locations where a process and/or storage occurs at each and wherein the process and/or storage at each location are either (i) controlled by different parties, (ii) have a distance between them of at least about 0.1 miles, or (iii) if two different processes, can be independently run.

As used herein, the term “waste heat” includes any available heat that can be used to treat sludge. In one non-limiting example, waste heat is generated from a process wherein the heat can be captured and directed. This type of waste heat can include heat generated from a process such as, without limitation, a manufacturing process, a landfill degradation process or a geothermal process. As other non-limiting examples, waste heat can include any available heat generated from a system that utilizes gas and/or a steam turbine. A particular non-limiting example of waste heat can include steam from any number of sources including, without limitation, steam from a steam turbine or bleed steam from a turbine. Waste heat can also come from a Heat Recovery Steam Generator (HRSG) configuration and stack. Waste heat can also come from biofuel sources, which heat can be obtained from combustion and/or other exothermic reactions. Waste heat can also include any available heat, including heat from coolant, lubricant and/or exhaust, generated from a system that utilizes a reciprocating engine, which engine can be powered by any fuel, including without limitation combustible gasses produced by a landfill or waste degradation process. Waste heat can also include any available heat, including heat from coolant, lubricant and/or exhaust, generated from a gas generator set, or a gas turbine set, the gas generator or turbine being powered by any fuel, including without limitation combustible gasses produced by a landfill or waste degradation process. Waste heat can further include heat generated from a solar process that is used to dry sludge. As should be understood by this wide range of examples, waste heat can come from any number of sources and includes any type of heat that can be used to treat sludge but is not created for the sole purpose of treating sludge.

As used herein, the term “regional sludge drying service” includes a service that utilizes waste heat to treat sludge for at least two other parties.

### DETAILED DESCRIPTION OF THE INVENTION

Traditional sludge disposal methods are becoming more complex and prohibitively expensive for wastewater treatment facilities to process and dispose of sludge. The disclosed embodiments according to the present invention provide for methods employing one or more of a combination of systems and methods to efficiently process and dispose of sludge generally and on behalf of other parties. Wastewater treatment facilities can benefit by being able to dispose of sludge without having to invest in expensive technologies that are now needed to comply with regulatory requirements. When done on behalf of another party, those performing the methods according to the present invention can benefit by receiving fees from wastewater treatment facilities for their services as well as by taking advantage of the nutrient, soil-enhancing, and fuel and energy rich properties of the treated sludge, as described below.

In one embodiment of a method according to the present invention the method includes one or more of treating sludge utilizing waste heat from a source, where the waste heat source is one or more of a biofuel, a reciprocating engine, a gas generator set, a gas turbine set, landfill, or a by-product of landfill degradation. The treatment of sludge can include dewatering the sludge, drying the sludge, and converting the sludge into a second form after it is dried. It is also possible to convert this dried sludge into a second form. Second forms can include, but are not limited to a fuel, electric power, a material suitable for a landfill application, a material suitable for an agricultural application, and a material suitable for an industrial application. In addition the treating of the sludge and the converting of the sludge can take place at separate locations. In addition the waste heat can be obtained from biofuel utilizing an exothermic reaction of the biofuel. One type of exothermic reaction disclosed herein is combustion. In addition the waste heat can be obtained from the exhaust, coolant or lubricant of a reciprocating engine. Alternatively or in addition, the waste heat can be obtained from the exhaust, coolant or lubricant of a gas generator set. Alternatively or in addition, the waste heat can be obtained from the exhaust, coolant or lubricant of a gas turbine set. Alternatively or in addition, the waste heat can be obtained from landfill utilizing an exothermic reaction of the landfill. One type of exothermic reaction disclosed herein is an exothermic reaction facilitated by microbes. In another type of exothermic reaction disclosed herein, the exothermic reaction is combustion. Furthermore, the landfill can be municipal landfill and/or commercial landfill. In addition the waste heat can be obtained from an exothermic reaction involving a by-product of landfill degradation. One type of by-product disclosed herein is a volatile organic compound, such as methane. Furthermore, the sludge can be accepted from more than one party. In addition, the waste heat can be provided by more than one party. Embodiments disclosed herein also utilize waste heat obtained from a location separate from the location where treating and/or converting of the sludge takes place.

Embodiments disclosed herein also include entering into an agreement with another party or parties, accepting sludge from the another party or parties, and treating the sludge based on an understanding created by the agreement. In a particular embodiment, treatment of the sludge can include dewatering the sludge utilizing waste heat, drying the sludge utilizing waste heat and/or, after drying, converting the sludge into a second form that can be useful in various aspects. The dewatering, drying and/or conversion of the sludge utilizing waste heat can, in certain embodiments, be augmented through the use of additional heat, vacuum drying, or other appropriate methods known to those of ordinary skill in the art.

In accordance with the present invention, sludge can be treated according to the methods described herein. Sludge can also be accepted from any party or parties that have a need to dispose of the sludge including, without limitation, a city, a municipality, a county, a state, the federal government, a public organization, a private organization, a business entity, and/or combinations thereof. In particular embodiments, the sludge can be accepted from at least two such parties. In one specific embodiment, the sludge is accepted from a municipal wastewater treatment facility.

In particular embodiments, the waste heat can be obtained from one or more of, without limitation, a stack flue gas, a coolant, water from a cooling tower, steam, steam from a turbine, bleed steam from a turbine, a Heat Recovery Steam Generator (HRSG) configuration and stack, waste heat from any system that utilizes a gas and/or a steam turbine, a landfill gas, a landfill methane gas, a geothermal source, a solar source, a solar source through the use of solar concentrators, solar thermal, biofuel, a reciprocating engine, a gas generator set, a gas turbine set, landfill, or a by-product of landfill degradation, or combinations thereof.

Dried sludge can be used as a fuel by a number of different parties in embodiments according to the present invention. For instance, the party that dried the sludge can use it as a fuel. Additionally, dried sludge can be provided to third parties for a number of uses, including, without limitation, its use as a fuel. Dried sludge can also be supplied, without further processing when desired, to an existing EGU such as, without limitation, a boiler, a cement plant kiln, a coal fired plant, etc.

In other non-limiting embodiments disclosed herein, dried sludge can be converted into a second form that can be useful in various aspects with any systems or methods known in the art. The second form can include, without limitation, a different fuel type, electric power, a material suitable for a landfill application, a material suitable for an agricultural application, a material suitable for an industrial application or combinations thereof.

It is also contemplated that the sludge can be accepted, dewatered, dried, and/or converted at separate locations or at the same locations, and that the locations can vary depending on the economical, environmental and/or regulatory requirements for transporting, dewatering, drying and/or converting the particular batch of sludge. In one particular embodiment, a facility that generates waste heat is used as a sludge treatment location and sludge from a variety of parties in the area is brought to the facility in a raw or partially dewatered form. Raw or partially dewatered sludge can be transported in, without limitation, a sealed, filtered, ventilated or odor-mitigating compartment. The acceptance of raw sludge from other parties can be especially beneficial for those parties because they can enjoy less digestion and retention time, an increased dewatering capability, a decrease in the use of polymers, a higher energy/BTU value, a deferral of capital equipment expenditures and a decrease in labor, maintenance and other general operational costs. Waste heat from the facility is then used to treat the sludge. In this regard, the facility can provide a regional sludge treatment service. Following treatment at the facility, the sludge can be put to a number of beneficial uses which will be described in more detail below. These uses can occur at the sludge treatment facility or at other locations. The following description describes particular processes for using waste heat to dry sludge although it should be understood that sludge can be treated by a number of different effective methods. In certain aspects the present invention will include providing a regional sludge treatment service. Again, the following examples are provided as examples only and are not intended to limit the scope of the present invention.

### Systems for Utilizing Waste Heat to Dry Sludge and Generate Energy

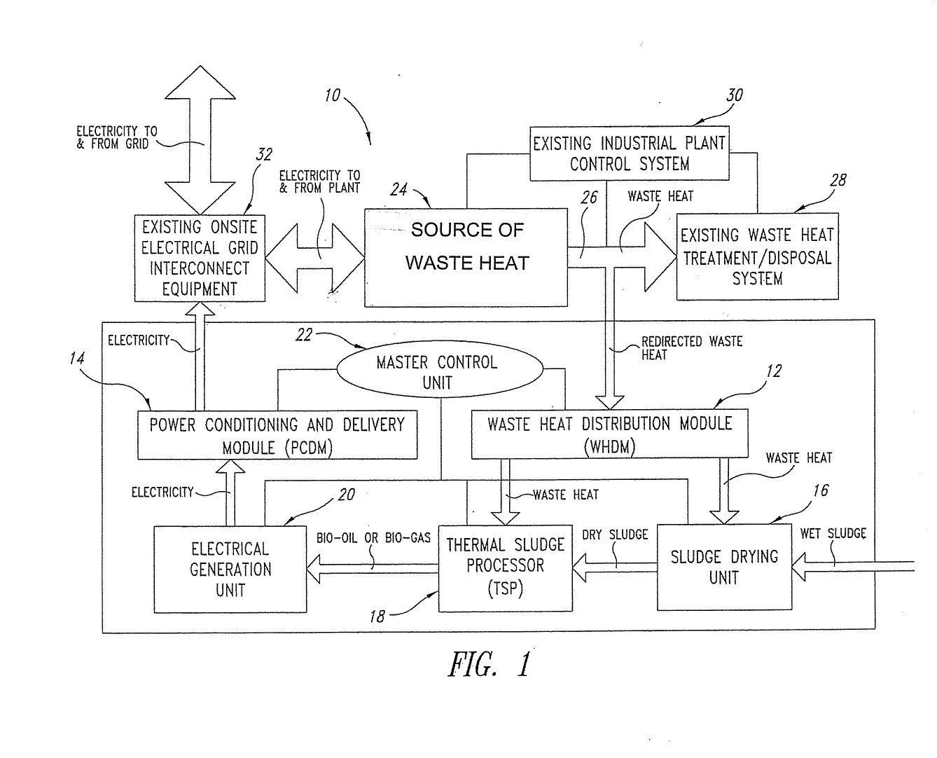

In one embodiment, as shown in FIG. 1, a system 10 or method for utilizing waste heat to dry sludge and generate energy includes a Waste Heat Distribution Module (WHDM) 12, a Power Conditioning and Delivery Module (PCDM) 14, a Sludge Drying Unit (SDU) 16, a Thermal Sludge Processor (TSP) 18 and an Electrical Generation Unit (EGU) 20. All of the above devices can be integrated via a Master Control Unit (MCU) 22 into a single process designed to safely dispose of waste heat and dry de-watered sludge while generating surplus energy.

In one embodiment disclosed herein, an existing source of waste heat 24 can be modified to allow for the diversion of waste heat 26 to the SDU 16 and/or TSP 18. These modifications can include, without limitation, the installation of diversion valves and/or piping that can feed directly into the WHDM 12. In one embodiment, the WHDM 12 can be built as a unit that is separate from the existing source 24 and can require no monitoring or control by source staff. In another embodiment, the WHDM 12 can be located adjacent to the source 24 to allow for easy conveyance of waste heat via, without limitation, the above mentioned systems.

In embodiments according to the present invention described thus far, no further changes to source operations, personnel, or management practices other than the diversion of waste heat are required. It is to be understood, however, that the systems and methods according to the present invention can also be applied to the construction of an entirely new system instead of or in addition to the utilization of waste heat from an existing source 24. In these embodiments, the new source could be streamlined in several respects, including, without limitation, having a master control unit (MCU) 22 to control all units of the entire system.

In various embodiments according to the present invention, the WHDM 12 can contain, without limitation, ducts, valves, sensors and/or control logic (not shown) to convey an appropriate amount of waste heat to the SDU 16 and/or TSP unit 18. In particular, the WHDM 12 can direct waste heat into the SDU 16 at a proper rate to maintain desired temperatures and evaporative capacities. The SDU 16 can be of any suitable type, including but not limited to direct and indirect convective thermal dryers, contact surface dryer, spray dryers, fluid bed dryers, and various hybrid solar/convective type dryers.

As described earlier, in certain non-limiting embodiments according to the present invention, dried sludge (dried by waste heat in accordance with the present invention or otherwise) can be fed into a TSP unit 18 where it can be converted under heat and/or pressure to an energy source. Non-limiting examples of such energy sources include fuels such as, without limitation, bio-oil, bio-gas, char, or combinations thereof. The WHDM 12 can also provide for the precise distribution of waste heat to portions of the TSP 18 to augment certain stages of the process. By augmenting heat from the TSP 18 process itself with waste heat from the WHDM 12, the TSP 18 can be optimized to produce an efficient amount of fuel for power generation purposes.

In one embodiment of the systems and methods according to the present invention, a Power Conditioning and Delivery Module (PCDM) 14 can coordinate the conditioning, accounting, and delivery of electrical power generated through combustion of the fuel in the Electrical Generation Unit (EGU) 20. The EGU 20 can include, but is not limited to, a steam generator, Stirling Engine, turbine, steam turbine, or traditional reciprocal engine. Any appropriate power generation technology that can utilize the fuel produced in the TSP is acceptable. It is important to note that the fuel itself can be the end product to be used either for onsite combustion and/or distribution for other uses. Additionally, fuel such as bio-oil can be further refined into other oil-derived products including, but not limited to, diesel, gasoline and/or heating oil.

Finally, in another embodiment according to the present invention, an integrated Master Control Unit (MCU) 22 can provide managers of the sludge drying process, sludge conversion process, or both with, for example and without limitation, real-time process monitoring, automated control logic and alarm/fault notification and recovery systems. This control module 22 can but need not be entirely separate from the pre-existing control system 30 that can be used by an existing source 24 that provides waste heat (i.e., the power plant, pulp mill, landfill, gas generator set, gas turbine set, reciprocating engine, etc.).

Thus, in operating the systems and methods depicted in FIG. 1, the existing source 24 is modified to divert all or a portion of the waste heat 26 it produces to the waste heat distribution module 12. The waste heat is distributed by the WHDM 12 to the sludge drying unit 16 and/or the TSP 18. The sludge drying unit 16 receives raw sludge and/or partially dewatered sludge that is then dried in whole or in part by utilizing the diverted waste heat distributed by the WHDM 12. The dried sludge can be processed at the TSP using additional waste heat provided by the WHDM 12 to form a fuel or reusable fuel, including, without limitation, bio-oil, bio-gas, char, or combinations of bio-oil, bio-gas and char. In one embodiment the fuel can then be consumed by an electric generator unit 20 to generate electricity. In one embodiment, the electricity can be conditioned and delivered to electrical grid interconnect equipment 32. From the interconnect equipment 32, the electricity can then be distributed to an electric grid. In addition, electricity generated from the existing facility, to the extent it is generated therein, can also be distributed to the electrical grid interconnect equipment 32. In another embodiment, the electricity (from the EGU 20, PCDM 14, electrical grid interconnect equipment 32, and/or existing industrial plant 24) can be stored, for example in one or more batteries, onsite and/or in a remote location, for later distribution. In one specific embodiment, the electricity can be stored in one or more batteries and then can be distributed to the electrical grid interconnect equipment 32 where it can be distributed to an electric grid.

Revenue from the systems and methods disclosed herein can come from multiple sources. For example, when electrical power is generated, the PCDM 14 and integrated control system 22 can precisely monitor the amount of electrical power (both kW and kWh) delivered to the interconnect equipment 32 for the general utility grid. The operators can be compensated for this power based upon negotiated rates paid by the electrical utility. Revenues can also come from other uses including, without limitation, the sale of the dried fuel itself as, for example and without limitation, a wood or coal substitute.

Second, because the source 24 providing waste heat 26 could normally incur substantial expenses to eliminate this waste heat in an environmentally sound manner, the operators or users of various sources can compensate the operators of the present invention. In one embodiment this compensation can be based upon the value of avoided costs. This value can also be determined through negotiation and can be based upon the quantity of waste heat utilized by the sludge processing system.

Third, municipal and private wastewater facilities must dispose of raw or partially dewatered biosolids and sludge. Current methods for doing so can be expensive, depending upon the distance the material must be hauled and the possibility of environmental contamination from other forms of disposal. Environmental concerns can be mitigated or eliminated via the sludge drying and processing systems and methods described herein, especially when raw sludge is accepted. It is thus expected that various aspects of the processes described herein can provide a lower cost and/or an environmentally beneficial alternative for sludge disposal than other methods currently used. In one embodiment according to the present invention, specific rates to be charged per ton or per gallon for sludge disposal can be negotiated individually with wastewater source operators or other relevant parties and the systems and methods described herein can provide cost-effective and/or an environmentally sound regional sludge treatment and drying facilities as well as energy and/or other useful dried sludge by-products.

### Methods for Utilizing Waste Heat to Dry Sludge and Generate Energy

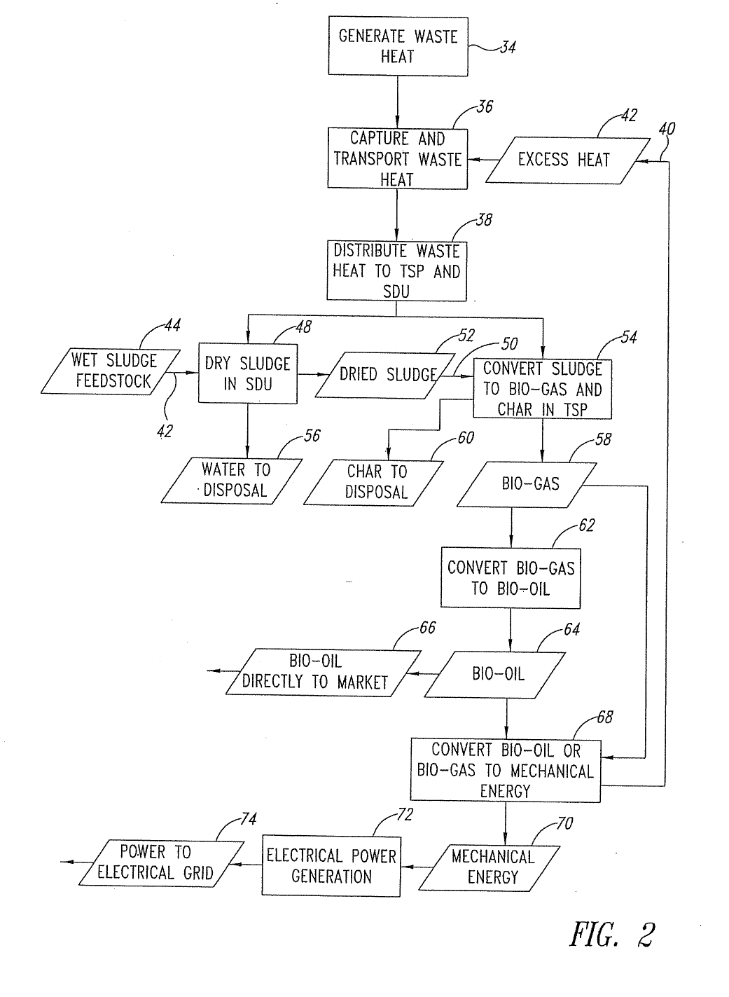

FIG. 2 illustrates one non-limiting method for utilizing waste heat for drying sludge and for converting the dried sludge to produce a secondary fuel type (as opposed to the dried sludge itself which, as previously stated, is also a fuel type), which can be used to generate electricity or for other beneficial purposes in accordance with the present invention:

Step 1: Generate Waste Heat (34). Waste heat can be produced by a number of different sources, including, without limitation, power generation (coal-fired, natural gas fired, nuclear, etc.), wood product processing (pulp & lumber mills) and various other heat-producing processes including without limitation, waste heat produced from a biofuel, a reciprocating engine, a gas generator set, a gas turbine set, landfill, a by-product of landfill degradation and combinations thereof. In one particular embodiment, waste heat can include steam or bleed steam from a turbine through a bleed steam valve. In another particular embodiment, waste heat can include heat from a landfill. The methods according to the present invention can include modifying an existing source and/or constructing one or more such sources in order to create a readily available source of waste heat for downstream sludge drying, processing, and/or power generation processes.

Step 2: Capture and Transport Waste Heat (36). The systems and methods according to the present invention include an apparatus to collect heat from the waste heat source (e.g., a heat-producing manufacturing process, a geothermal source, a landfill, a gas generator set, etc.) in the form of, without limitation, heated air (e.g., a stack flue gas, a landfill methane gas, etc.), steam, steam or bleed steam from a turbine, from a Heat Recovery Steam Generator (HRSG) configuration and stack, liquid (e.g., a coolant or lubricant), exhaust or other useable forms. This apparatus can consist of heat exchangers installed in the heat stream from the heat source, where heat can be captured prior to other forms of disposal. The apparatus can include all necessary valves, ducts, fans, pumps, and piping to redirect the heated material. In one embodiment this apparatus is the Waste Heat Distribution Module (WHDM; not shown). In another embodiment this apparatus collects and delivers heat to the WHDM.

Step 3: Distribute Waste Heat to TSP and/or SDU (38). The WHDM can control the delivery of waste heat to the downstream sludge drying and/or thermal processing stages using, in one embodiment, an automated control system. Using sensors located throughout one or more modules and processes, the WHDM can measure instantaneous heat requirements and can operate all necessary valves, ducts, piping, fans and pumps to deliver the required heat from the waste heat source. The WHDM can also coordinate the collection of heat from the thermal processing stage when used and in one embodiment can redirect this heat back into the overall process.

Step 4: Dry Sludge in SDU (48). In one embodiment, the primary consumer of waste heat delivered by the WHDM can be a Sludge Drying Unit (SDU) (not shown). This SDU can consist of an apparatus to convey raw sludge and/or partially dewatered sludge 44 (in certain embodiments about 70-80% moisture content) from a storage facility or delivery vehicle into the sludge dryer at an appropriate rate. The sludge dryer can force the raw sludge and/or partially dewatered sludge through a process 48 whereby heat can be used to drive off excess moisture—in some embodiments leading to a final moisture content in the sludge of less than about 20%, less than about 15%, less than about 10%, or less than about 5%. In one embodiment, the sludge dryer can force the raw sludge or partially dewatered sludge through a process 48 whereby heat can be used to drive off excess moisture, leading to a final moisture content in the sludge of less than about 10%. In certain embodiments, the SDU can then convey (50) the dried sludge 52 directly to a thermal processing processor (TSP) (not shown) at the appropriate rate for further processing 54. Moisture laden hot air or steam from the SDU can be vented to the atmosphere where the moisture will quickly evaporate. Alternatively or in combination, hot air from the SDU can be vented to the SDU for further sludge drying or to a TSP as appropriate. In another embodiment, the exhaust air can be quenched and condensed to produce liquid water 56. In one specific embodiment, the liquid water 56 can be discharged into the local wastewater treatment system. In another specific embodiment, the liquid water 56 can be used for condensing hot air/steam, bio-gas or both, before it can be discharged into the local wastewater treatment system.

Step 5: Convert Sludge to Bio-Gas or Char in TSP or Other Useful End Products. Dried sludge can have a number of beneficial uses. Thus, in certain embodiments, following drying, the dried sludge is stored for later use and/or sold or traded for later use. In certain embodiments, after sludge is dried, it can be converted into a second form. In one non-limiting example, a TSP can use a high-temperature, oxygen free process 54 to convert incoming dried sludge 52 to a combination of, without limitation, bio-gas 58 and char. Char is a carbon-rich solid by-product of the conversion process 54 that can be collected at the end of the process and can be disposed (60) in a number of environmentally beneficial ways. For example, bio-gas and/or char (and other potential end products) can be sold to commercial users or used for research purposes. In certain embodiments, the TSP process can be self sustaining, creating enough heat to maintain an ongoing reaction. However, energy from the WHDM can also be used to augment the creation of the high-temperature environment required for successful TSP reactions.

Step 6: Convert Bio-Gas to Bio-oil (62). If bio-gas is formed, the bio-gas can or can not be condensed into a liquid bio-oil 64. Some devices require a liquid fuel (i.e., diesel engines) while others can be run directly on gas, or from heat generated by the combustion of either gas or oil. In some instances, when formed, the bio-oil can be of high enough quality to sell directly to outside markets (66).

Step 7: Convert Bio-oil or Bio-gas to Mechanical Energy (68). When formed, the energy-rich bio-oil or bio-gas can be combusted to produce heat or direct mechanical energy 70. Examples of this step can include, without limitation, using liquid bio-oil in place of diesel fuel to power a standard reciprocating engine—thus turning a drive shaft attached to the generator in the next step. Other systems can be configured to burn bio-gas in a boiler to create heat that can be converted to mechanical energy via a Stirling Engine or other form of “heat” engine. Still other configurations can involve the direct combustion of bio-gas in micro-turbines, again forcing the rotation of a drive shaft coupled to the Electrical Generation Unit (EGU). Yet still other configurations can involve directing and using hot air or steam from the SDU to augment the production of mechanical energy 70. In most cases, some amount of waste heat 42 can be created by this process. In one embodiment, this waste heat 42 can be collected and delivered (40) back into the WHDM for further use in the overall process.

Step 8: Electrical Power Generation (72). When mechanical energy 70 is generated through the combustion of bio-oil or bio-gas, in certain embodiments this mechanical energy can be converted into electrical energy using common generator technologies. Electrical power can then be properly conditioned and delivered (74) onto a power grid by, for example, an integrated Power Conditioning and Delivery Module (PCDM).

The processes described herein also can generate dried fuel materials useful in a variety of applications. For example, dried sludge can be combusted to power a number of different processes. In addition to energy generation, dried sludge can also be put to a number of other different beneficial uses, some of which are described below.

### Industrial Applications

In one embodiment according to the present invention, the sludge can be converted into a material suitable for an industrial application using, for example and without limitation, the methods as disclosed by co-pending U.S. patent application Ser. No. 11/427,425, filed Jun. 29, 2006 (the '425 application), the content of which is incorporated herein in its entirety by reference.

Briefly, the sludge can be converted into char using a pyrolysis process as described in the '425 application. In certain embodiments, the char comprises a Brunauer, Emmett and Teller surface area of between about 400 m²/g and about 600 m²/g. Industrial purposes according to the present invention can include, without limitation, the char being used as a pore generator in brick manufacturing, as a carbon black substitute, or both. In certain embodiments, the char can be converted to activated carbon. Activated carbon can be used for additional industrial applications including, without limitation, the absorption of metals; air purification; liquid purification, catalyst support; decolorization of beverages, sugar refining, deoderization, emergency poison treatment, solvent recovery and whiskey manufacturing.

### Agricultural Applications

In one embodiment according to the present invention, the sludge can be converted into a material suitable for an agricultural application, for example and without limitation, a fertilizer. In one specific embodiment, the sludge is dried by heating to produce a Class A biosolid that has desirable characteristics for a fertilizer. A Class A biosolid, as defined in 40 C.F.R. Part 503, is a biosolid that has met “the highest quality” pathogen reduction requirements confirmed by analytical testing and/or the use of a Process to Further Reduce Pathogens (PFRP) as defined in 40 C.F.R. Part 257. One advantage of a Class A biosolid is that it is approved for unrestricted use. For example, a Class A biosolid that also meets appropriate metals limits and vector attraction reduction requirements can be used for residential purposes, such as for use on lawns and home gardens. It can also be land-applied in public areas without restriction in addition to use as an agricultural amendment.

If a Class A biosolid is to be produced, a system to monitor the drying/converting process can be incorporated to ensure (1) that the moisture content of the biosolid is about 10 percent or lower and (2) that the temperature of the sludge/biosolid reaches or exceeds about 80° C. In addition, the biosolid should be tested for fecal coliform bacteria or Salmonella sp. at the last point before being used for agricultural applications.

In addition to the regulatory requirements listed above, a material suitable for an agricultural application (in one embodiment, a fertilizer) can have one or more of the following characteristics in various combinations that can be controlled to improve its marketability: (1) Odors: The material can be substantially free of offensive orders. As discussed, raw sludge and/or partially dewatered sludge can be anaerobically digested prior to further processing. Undigested sludge tends to create more odorous material. As such, one way to reduce odor is to digest sludge prior to drying and/or converting. In addition, the material can be properly stored to ensure that it is not exposed to moisture before use as exposure to significant moisture can lead to further decomposition (leading to odors). (2) Nutrient content: Sufficient nutrients should be present in the material to warrant the costs associated with transporting and applying them as, for example, a fertilizer. As such, a reliable sampling program can be established to determine the nutrient content at the various steps. (3) Mechanical durability: The material should be tested to ensure that it will maintain its form through bagging, conveyance, handling and storage. (4) Particle size: Material suitable for agricultural applications can be in the form of a pellet range in size from about 1 to about 4 mm and substantially spherical in shape. This can avoid end users associating irregular pellet sizes with an inferior product. (5) Dust: Dust can be problematic for several reasons. First, dust can be an explosion hazard. Second, dust can cause human health problems, and third, some potential end-users can not accept dusty products. Dust can be generated because the sludge/material was not sufficiently dried and hardened during drying or because the material was not processed to minimize its potential to cause dust. Repeated handling of some materials during storage and/or transport, can also result in dust generation. Coating the material with vegetable oil or paraffin can minimize the occurrence of dust.

### Landfill Applications

Sludge can be converted into a material suitable for landfill applications. To reduce the possibility of groundwater, surface water, and air quality degradation, such landfill applications can be operated according to standards applicable to sanitary landfills. Such conformance is required for publicly owned treatment works on the federal level by 40 C.F.R. § 257, promulgated by the US Environmental Protection Agency under the Resource Conservation and Recovery Act and the Clean Water Act. The criteria prescribe performance standards for disposal facilities which address eight broad categories of environmental and public health effects. Additional requirements can also apply at the state and local levels. Material suitable for landfill applications generally needs to have a moisture content of about 85% or less.

As should be understood from the preceding description, the presently described methods provide a number of important benefits and advancements in the treatment and use of organic sludge, converting such sludge from an expensive to dispose of waste product to an efficiently disposed of waste product that can be converted into a number of beneficial products and uses. The methods according to the present invention provide these benefits in part by providing regional facilities that can dry and/or treat organic sludge for a number of parties in the area.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Certain embodiments of this invention are described herein, including the best mode known to the inventors for carrying out the invention. Of course, variations of these embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, references have been made to patents and/or printed publications throughout this specification. Each of the above cited references and printed publications are herein individually incorporated by reference in their entirety.

In closing, it is to be understood that the embodiments of the invention disclosed herein are illustrative of the principles according to the present invention. Other modifications that can be employed are within the scope of the invention. Thus, by way of example, but not of limitation, alternative configurations according to the present invention can be utilized in accordance with the teachings herein. Accordingly, the present invention is not limited to that precisely as shown and described.

1. A method comprising:
treating sludge utilizing waste heat wherein the source of said waste heat is selected from the group consisting of a biofuel, a reciprocating engine, a gas generator set, a gas turbine set, landfill, a by-product of landfill degradation and combinations thereof.

2. A method according to claim 1 wherein said treating comprises a treatment selected from the group consisting of dewatering said sludge, drying said sludge, converting said sludge into a second form after it is dried, and combinations thereof.

3. A method according to claim 2 wherein said method further comprises:
converting said dried sludge into a second form wherein said second form is selected from the group consisting of a fuel, electric power, a material suitable for a landfill application, a material suitable for an agricultural application, a material suitable for an industrial application, and combinations thereof.

4. A method according to claim 3 wherein said treating of said sludge and said converting of said sludge take place at separate locations.

5. A method according to claim 1 wherein said waste heat source is said biofuel utilizing an exothermic reaction of said biofuel.

6. A method according to claim 5 wherein said exothermic reaction is combustion.

7. A method according to claim 1 wherein said waste heat source is one or more of the exhaust, coolant or lubricant from said reciprocating engine.

8. A method according to claim 1 wherein said waste heat source is one or more of the exhaust, coolant or lubricant from said gas generator set.

9. A method according to claim 1 wherein said waste heat source is one or more of the exhaust, coolant or lubricant from said gas turbine set.

10. A method according to claim 1 wherein said waste heat source is said landfill utilizing an exothermic reaction of said landfill.

11. A method according to claim 10 wherein said exothermic reaction is facilitated by microbes.

12. A method according to claim 10 wherein said exothermic reaction is combustion.

13. A method according to claim 10 wherein said landfill is selected from the group consisting of municipal landfill, commercial landfill, and combinations thereof.

14. A method according to claim 1 wherein said waste heat source is said by-product of landfill degradation utilizing an exothermic reaction.

15. A method according to claim 14 wherein said by-product of landfill degradation is a volatile organic compound.

16. A method according to claim 15 wherein said volatile organic compound is methane.

17. A method according to claim 14 wherein said exothermic reaction is combustion.

18. A method according to claim 1 wherein said sludge is accepted from more than one party.

19. A method according to claim 1 wherein said waste heat is provided by more than one party.

20. A method according to claim 1 wherein said waste heat source is obtained from a location separate from the location where said treating or said converting takes place.
